(19) United States
(12) Patent Application Publication
(10) Pub. No.: US 2003/0081428 A1
(43) Pub. Date: May 1, 2003

(54) Device and method for uniform contact illumination

(75) Inventor: Uri Neta, Koranit (IL)

Correspondence Address: DR. MARK FRIEDMAN LTD., c/o Bill Polkinghorn, Discovery Dispatch, 9003 Florin Way, Upper Marlboro, MD, 20772, US

(73) Assignee: MEDVISION DEVELOPMENT LTD.

(21) Appl. No.: 09/985,080

(22) Filed: Nov. 1, 2001

(51) Int. Cl. G02B 5/02; F21V 13/04

(52) U.S. Cl. 362/558; 362/551; 362/327

(57) ABSTRACT

A device and a method for uniformly illuminating transparent or opaque objects while confining the illumination to those objects. The device consists of a radiation source and a transparent block. The device exploits total internal reflection to ensure that radiation introduced to the block by the radiation source propagates only within the block except where the block is in contact with the object to be illuminated. Where there is contact with the object, some of the radiation enters transparent objects, illuminating them from within or is diffusely reflected from opaque objects.

### FIELD AND BACKGROUND OF THE INVENTION

The present invention relates to a device and a method for uniform illumination and, more particularly, to a device and method for illuminating target objects with radiation in a way that restricts the illumination to the target objects.

There exist many applications where it is desirable to illuminate only a target object. In some such applications this is desirable in order to detect subtle features of the target object with greater contrast and without interference from radiation scattered by other illuminated targets. One such application is the detection of flaws in cut gemstones. These flaws can be detected by the radiation that the flaws scatter which differs in character from the radiation reflected and refracted by the facets of the gemstones. This detection of flaws can be made more reliable by restricting illumination to the gemstone so that radiation scattered by the background is not confused with radiation scattered by flaws.

Another such application is in the automated recording and identification of fingerprints by imaging of fingertips. Confining the illumination to the fingertips allows homogenous illumination of the object and reduces noise which arises from background radiation.

In all such applications, it is desirable that the target object be illuminated uniformly so that the intensity of radiation reflected or scattered from the target depends only on the properties of the target and not on the properties of the radiation source. Scanning the target with a stable radiation source such as a laser can simulate uniform illumination. In principle, the sum of images obtained by sequentially illuminating (scanning) contiguous portions of the target is equivalent to the image that would obtained by uniform illumination. However, scanning increases the complexity of the imaging device and decreases the confidence in the results obtained. In addition to the radiation source, the recording medium and the image processor, the imaging device must also have a scanning mechanism and means for synchronizing the scanning and the recording. Furthermore, illumination of an irregularly shaped target requires that either the scanning mechanism or the image processor have means such as an edge detection system for excluding images recorded while the radiation source illuminates past the edges of the target from the sum. To avoid the problems inherent in scanning, a radiation source for simultaneous uniform illumination must be two-dimensional.

Two-dimensional uniform radiationing in as of itself is not difficult. One simple way to achieve it is to cover a closely spaced array of point sources of radiation with a diffusing screen. These point sources could be as simple as incandescent radiation bulbs. The diffusing screen smears out the lateral variation in the intensity of radiation that impinges on it from the point sources and the radiation emerging from the other side of the screen is substantially uniform. The problem with such unsophisticated two-dimensional sources in the applications envisaged here is that it is difficult to confine the illumination to the target object. If all targets had the same shape a system of baffles could be used to limit the illumination. This is difficult when the targets are objects like gemstones (transparent to radiation) or fingertips (opaque to radiation).

There is thus a widely recognized need for a source of radiation that uniformly illuminates only a target object.

### SUMMARY OF THE INVENTION

The present invention exploits the phenomenon of total internal reflection to provide simultaneous uniform illumination with radiation waves of only a target object. As used herein, the term “radiation waves” refers to energy that propagates as wave, such as radiation or sound energy. Total internal reflection is a mode of propagation of radiation waves at the interface between two media. The first of the two media is termed the medium wherethrough the waves are propagating at an angle relative to the interface. The second of the two media is termed the surroundings. If the angle is equal to or greater than the critical angle of the interface, Θ_{critical}, the radiation does not exit the medium into the surroundings, but rather is reflected from the interface back into the medium. Θ_{critical} is determined by the index of refraction of the medium, n_{medium}, and of the surroundings, n_{surroundings}, according to equation 1:

$$sin ( {θ}_{critical} ) = \frac{{n}_{surroundings}}{{n}_{medium}}$$

From equation 1 it is clear that for a critical angle to exist, n_{medium} must be greater than n_{surroundings}. Typical indices of refraction for electromagnetic radiation are n_{vacuum}=1.0000, nₐᵢᵣ=1.0003, n_{water}=1.333, n_{plexiglas}=1.51, n_{crown glass}=1.52, n_{flint glass}=1.66, n_{diamond}=2.417 and n_{gallium phosphide}=3.50.

According to the present invention there is provided a device made up of a) a block that is substantially transparent to the type and range of frequencies of radiation used to illuminate, the block having at least one entry surface and at least one surface of total reflection so that the radiation introduced into the block via one of the entry surfaces at a suitable angle is totally reflected by a surface of total reflection and such that a portion of the at least one surface of total reflection is substantially uniformly irradiated by the radiation; and (b) a radiation source for introducing the radiation into the at least one entry surface at the suitable range of angles.

According to the present invention there is provided a suitably shaped block of material that is transparent to the appropriate wavelength, and a source of radiation generating the appropriate wavelength, hereinafter called the “radiation source”, that introduces radiation into the block through one or ore surfaces of the block, hereinafter called entry surfaces, in such a way that the radiation is incident on other surfaces of the block hereinafter called “surfaces of total reflection”, at angles greater than or equal to the critical angle of the material, and in such a way that the intensity of the radiation incident on the surfaces of total reflection is laterally uniform. In most applications envisaged, the radiation is visible radiation, but it could also be electromagnetic radiation with frequencies in the infrared or ultraviolet range or other type of radiation, such as ultrasonic waves.

When a transparent object, having an index of refraction n_{object} that is greater than that of the surroundings, is placed in contact with one of the surfaces of total reflection, the critical angle at the area of contact changes. If the index of refraction of the object is greater than the index of refraction of the block, then the conditions for total internal reflection are not satisfied and some of the radiation incident at the area of contact escapes the block into the object. If the index of refraction of the transparent object is less than the index of refraction of the block, then the critical angle at the area of contact is greater than the critical angle elsewhere along the surface of total reflection and some of the incident radiation on the area of contact at angles between the two critical angles may be transmitted into the transparent object.

The mechanism of total internal reflection assumes that the radiation incident on the surfaces of total reflection is reflected specularly. When an opaque object is placed in contact with one of the surfaces of total reflection, some of the radiation incident on the are of contact is reflected diffusely, rather than specularly. This radiation reenters the block and, according to the present invention, exits the block via other surfaces, hereinafter called “exit surfaces”.

The entry surfaces, the exit surfaces and the surfaces of total reflection may have any suitable shape and curvature. In most of the preferred embodiments of the invention described hereinbelow, the exit surfaces and surfaces of total reflection are substantially flat or cylindrical.

The phenomenon of total internal refection has been used in devices known in the art.

U.S. Pat. No. 4,668,861 describes a sandwich of a transparent sheet, a resilient sheet and a separator that can be used as a tactile sensor: radiation introduced into the transparent sheet undergoes total internal reflection except where the resilient sheet touches the transparent sheet.

U.S. Pat. No. 5,355,213 describes a device that uses total internal reflection to find surface flaws of a transparent block.

The present invention addresses the shortcomings of presently known means for uniform illumination of a transparent or an opaque object while confining the illumination to the object. The object is illuminated by placing the object in contact with at least one surface of total reflection when the radiation source is activated. Suitable means are then used to detect and process the radiation emerging from the object, in the case of a transparent object or from the corresponding exit surface in the case of an opaque object.

### BRIEF DESCRIPTION OF THE DRAWINGS

The invention is herein described, by way of example only, with reference to the accompanying drawings, wherein:

FIG. 1 is a conceptual sketch of the invention, illustrating the phenomenon of internal reflection;

FIG. 2 is a conceptual sketch illustrating the use of the present invention to illuminate a transparent object with an index of refraction that is greater than that of the transparent block;

FIG. 3 is a conceptual sketch illustrating the use of the present invention to illuminate a transparent object with an index of refraction less than that of the transparent block;

FIG. 4 is a conceptual sketch illustrating the use of the present invention to heat a pan of water;

FIG. 5 is a conceptual sketch illustrating the use of the present invention to illuminate an opaque object;

FIG. 6 is a conceptual sketch illustrating the use of the present invention to illuminate an object using sonic waves;

FIGS. 7A and 7B are conceptual sketches of the invention, illustrating how uniform illumination is achieved using a point source of radiation;

FIG. 8 is a conceptual sketch of the invention, illustrating how uniform illumination of the surfaces of total reflection is achieved using two collimated beams of radiation;

FIG. 9 is a perspective view of a preferred embodiment of the invention wherein the transparent block has the shape of a parallelopiped;

FIG. 10 is a perspective view of a preferred embodiment of the invention wherein the transparent block has the shape of a cylinder;

FIG. 11 is a perspective view of a preferred embodiment of the invention wherein the transparent block has the shape of a cylindrical tube; and

FIG. 12 is a side view of a preferred embodiment of the invention wherein the transparent block is saucer shaped.

### DESCRIPTION OF THE PREFERRED EMBODIMENTS

The present invention is of an illumination device. Specifically, the present invention can be used to uniformly illuminate transparent or opaque objects while restricting the illumination only to those objects.

The principle and operation of a uniform illuminator according to the present invention may be better understood with reference to the drawings and the accompanying description.

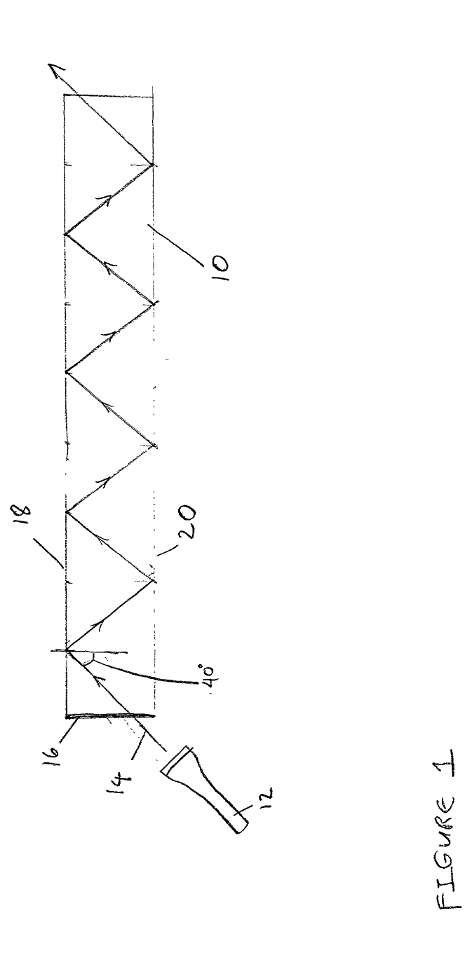

Referring now to the drawings, FIG. 1 illustrates the phenomenon of total internal reflection of visible electromagnetic radiation. Transparent flint glass block 10 has an index of refraction of n_{block}=1.66 is surrounded by air, nₐᵢᵣ=100. As a result, Θ_{critical} at the glass/air interface is 37°. Radiation source 12 shines radiation 14 through entry surface 16 at an angle of 40° from normal. Radiation 14 repeatedly reflects off the glass/air interface of upper surface 18 and lower surface 20. Under the conditions of FIG. 1, both upper surface 18 and lower surface 20 are surfaces of total reflection for radiation 14.

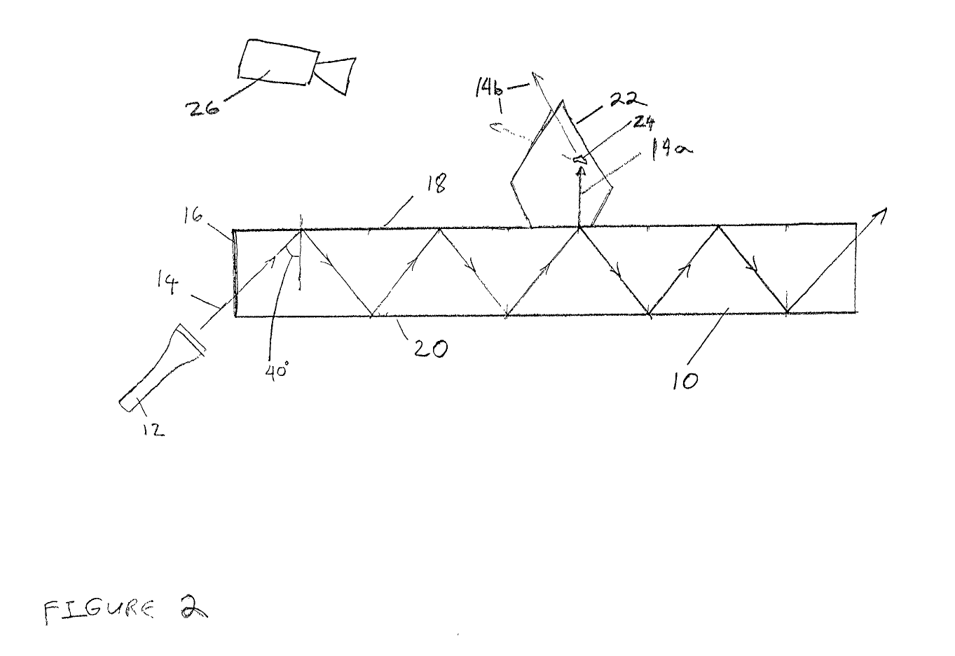

In FIG. 2, a diamond 22 with an index of refraction n_{diamond}=2.42 is placed onto upper surface 18 of glass block 10. Since n_{diamond}>n_{glass},, not all radiation 14 from radiation source 12 which impinges on the area of contact between diamond 22 and glass block 10 is reflected from the glass/diamond interface. Some of the radiation 14b is refracted upwards into diamond 22. As a result, diamond 22 is selectively illuminated from within. In a darkened chamber, diamond 22 will appear to glow from within while glass block 10 will be dark. A flaw 24, present in diamond 22, scatters some radiation, 14b. Scattered radiation 14b can be easily detected by means known to one skilled in the art, such as direct observation or a camera 26. It is important to note that it is preferable that upper surface 18 be substantially rigid, that is that it does not deform when in contact with an object that is placed thereupon.

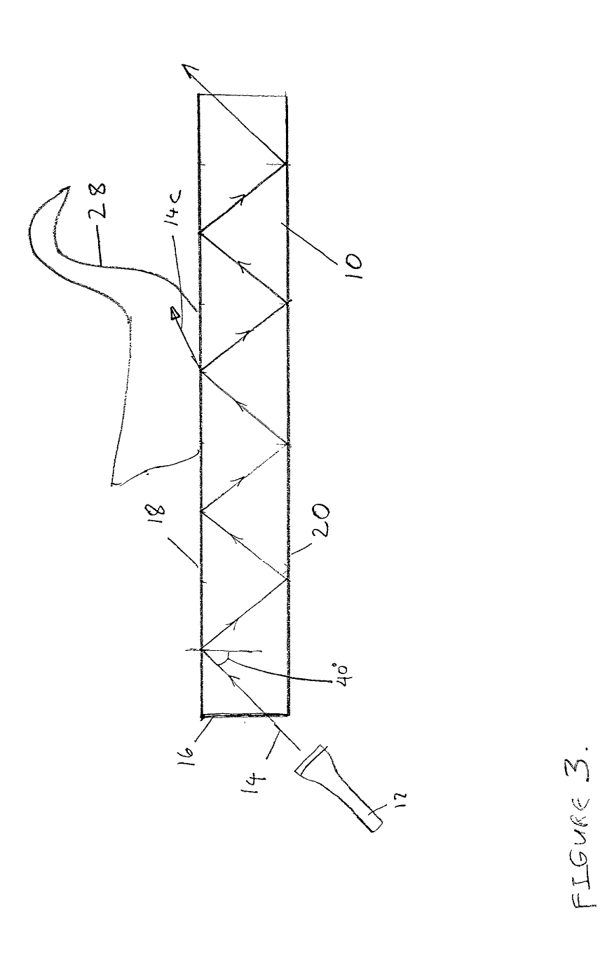

In FIG. 3, a cut glass swan 28 with an index of reflection n_{swan}=1.52 is placed on upper surface 18 of glass block 10. From equation 1, it is found that the critical angle at the glass/swan interface is 66°. Since radiation 14 from radiation source 12 impinges on the area of contact between swan 28 and glass block 10 at an angle of 40°, some radiation, 14c penetrates upper surface 18 and is refracted into swan 28. Swan 28 is selectively illuminated from within.

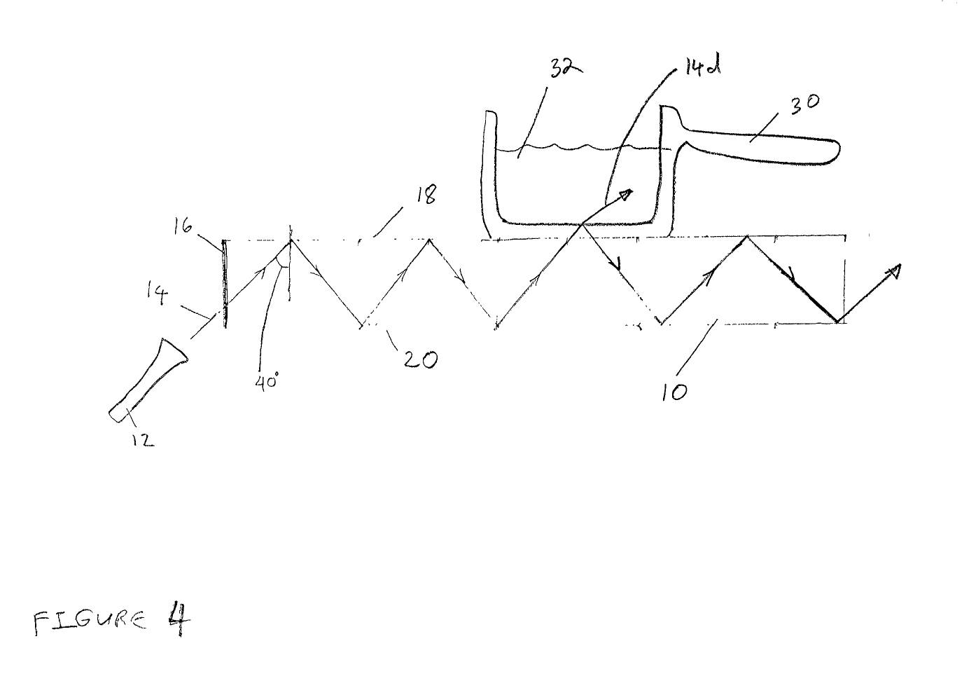

In FIG. 4, the present invention is used to selectively heat water 30 confined in glass vessel 32. Glass block 10 is transparent to infrared radiation and radiation source 12 is configured to produce a substantial percentage of radiation 14 with infrared frequencies. Since n_{water}=1.33, Θ_{critical} at a glass/water interface is 62°. When vessel 32 is placed on glass block 10, some radiation, 14d, penetrates through the surface of vessel 32 into water 30 and is absorbed by water 30, thus heating water 30.

It is clear to one skilled in the art that embodiments of the present invention, analogous to the embodiment described in FIG. 4, can be applied to chemical substances that react under the influence of irradiation. Such reactions include fluorescence for use in quantitative analysis, radiation-induced polymerization, ultrasonic cleaning or other radiation enhanced processes.

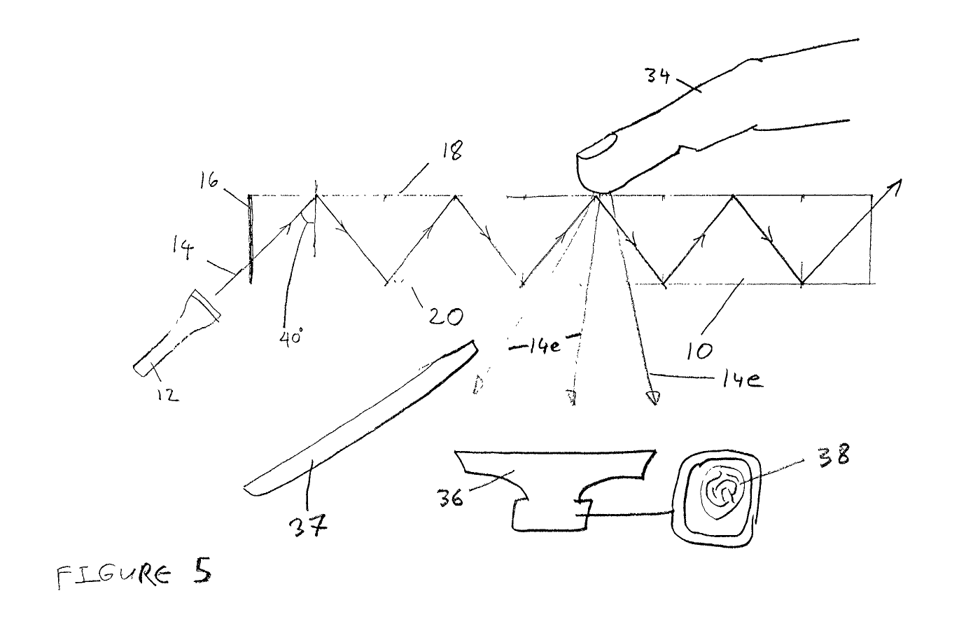

In FIG. 5, the use of the present invention in illuminating semi-opaque object 34 is depicted. Just as in FIG. 1, radiation source 12 shines radiation 14 through entry surface 16 of glass block 10 at an angle of 40° from normal. Radiation 14 repeatedly reflects off the glass/air interface of upper surface 18 and lower surface 20. Where opaque object 34 in contact with upper surface 18, some of radiation 14 is reflected diffusely 14e. Some of diffusely reflected radiation 14e penetrates through lower surface 20 to be detected by detector 36. In the case where opaque object 34 is a finger, detector 36 detects a clear image of a fingerprint 38. The device depicted in FIG. 5 is further equipped with a detector baffle 37 to shield detector 36 from any radiation excepting diffusely reflected radiation 14e.

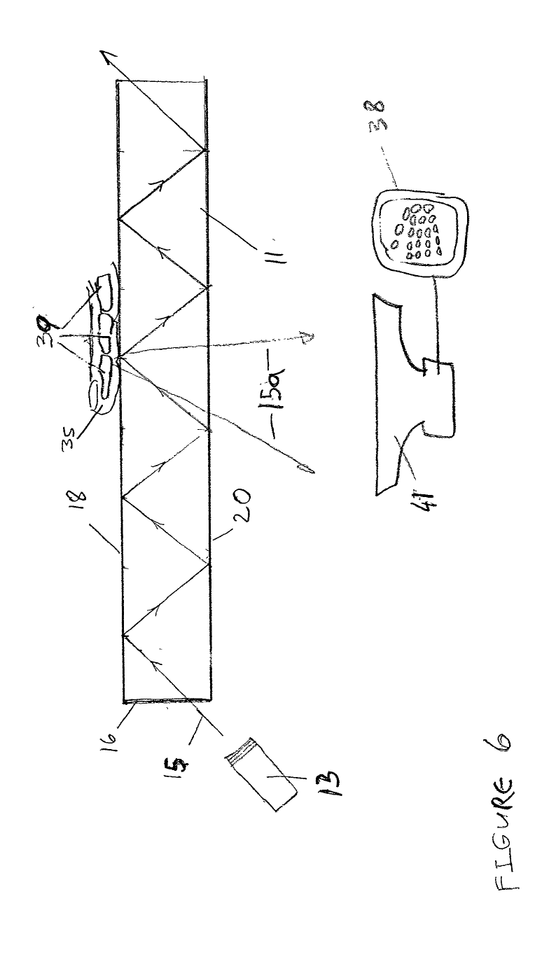

In FIG. 6 the use of the present invention to illuminating an object 35 using sonic radiation is depicted. An ultrasonic transducer 13 acts as a radiation source to direct sound waves 15 through entry surface 16 of plastic block 11. Sound waves 15 repeatedly reflect off the plastic/air interface of upper surface 18 and lower surface 20 due to the difference between the acoustic impedance (the sonic equivalent of index of refraction for electromagnetic radiation) of plastic and air. Where sonically-transparent object 35 in contact with upper surface 18, some of sound waves 15 penetrates object 35. Features 39 within object 35 that are opaque to sound waves 15 reflect sound waves 15a to detector 36. Images of features 39 produced from reflected sound waves 15a are displayed on monitor 38.

It is important to note that despite that two modes of operation of the present invention have been described separately hereinabove, both modes can be applied simultaneously. Thus an object that is not completely transparent will reflect radiation that can be detected as in the device depicted in FIG. 5. Simultaneously, some of radiation will penetrate the object that is not completely transparent and illuminate the object from within, as depicted in FIG. 3.

For objects, whether transparent or opaque to be uniformly illuminated by devices of the present invention such as those depicted in FIGS. 1 through 6, it is necessary that radiation 14 impinging on upper surface 18 (more generally, the surface of total reflection with which the object to be illuminated makes contact) be uniformly distributed.

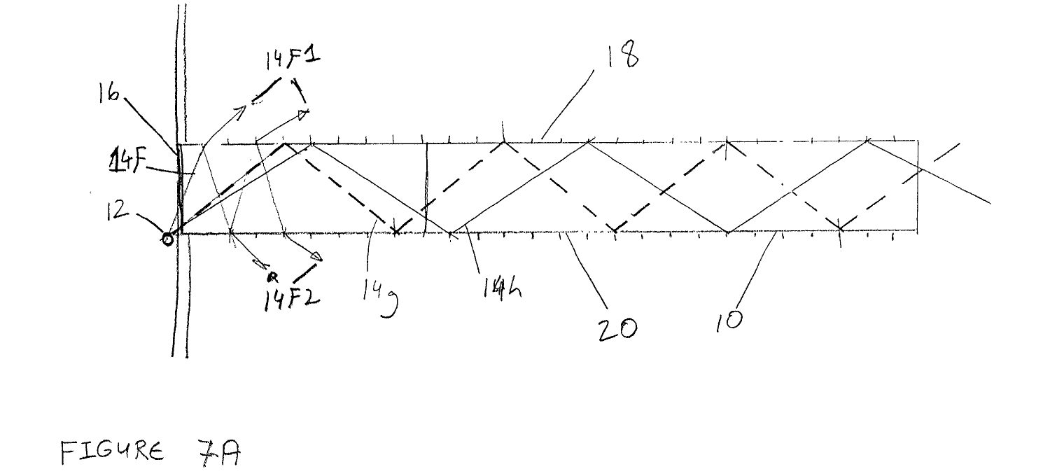

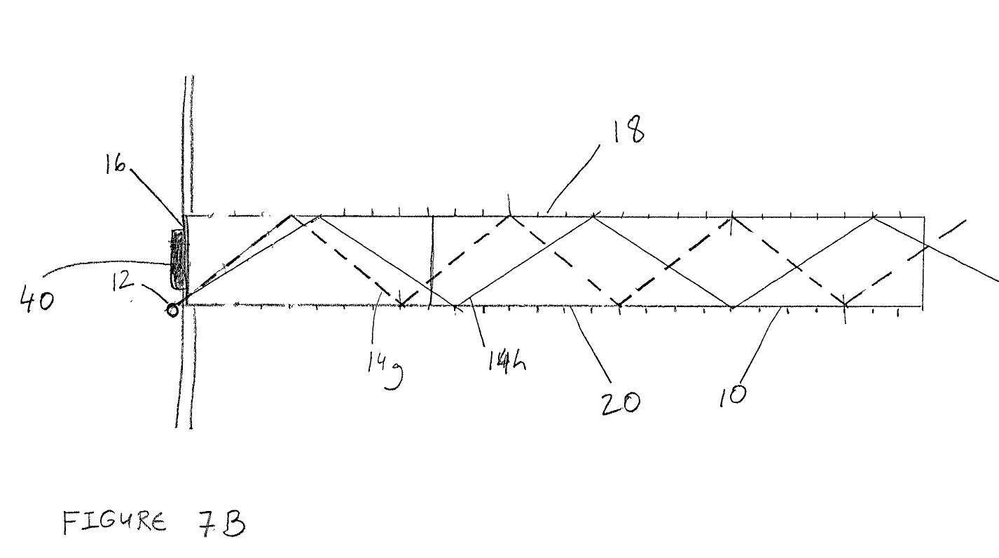

In FIG. 7, one way for this to be achieved is illustrated. In FIG. 7A, radiation source 12 is a point radiation source. Different radiation rays 14f, 14g and 14h enter block 10 at a wide range of angles. Radiation ray 14f enters at an angle that is less than Θ_{critical}, whereas radiation rays 14g and 14h enter at an angle that is greater than Θ_{critical}. Radiation rays 14g and 14h reflect off upper surface 18 and lower surface 20. Due to the different angles of entry of 14g and 14h, the frequencies with which 14g and 14h reflect off the surfaces of total reflection are different. As is clear to one skilled in the art, radiation source 12 produces a plurality of radiation rays 14 which enter block 10 with a continuum of angles, ensuring that the radiation rays which undergo total reflection are homogeneously distributed along the surfaces of total reflection of block 10.

When radiation rays such as 14f, which do not fulfil the conditions for total internal reflection, impinge on upper surface 18 or lower surface 20, the radiation ray is partially reflected back into block 10 and partially escapes out through either upper surface 18 (e.g. 14f1) or lower surface 20 (e.g. 14f2). At a sufficient distance from entry surface 16, radiation rays such as 14f, which do not meet the conditions for total internal reflection, are sufficiently dim to be substantially non-interfering for the purpose of illuminating an object.

In FIG. 7B, entry surface 16 is flanked by entry baffle 40. Entry baffle 40 ensures that only radiation rays 14 that meet the conditions for total reflection (such as 14g and 14h) enter through entry surface 16.

As is clear to one skilled in the art, ordinary diffuse sources of radiation, such as fluorescent lamps behave substantially as a dense array of point sources of radiation. Thus one suitable radiation source 12 for a device of the present invention, analogous the device depicted in FIG. 7, is a standard tubular fluorescent lamp.

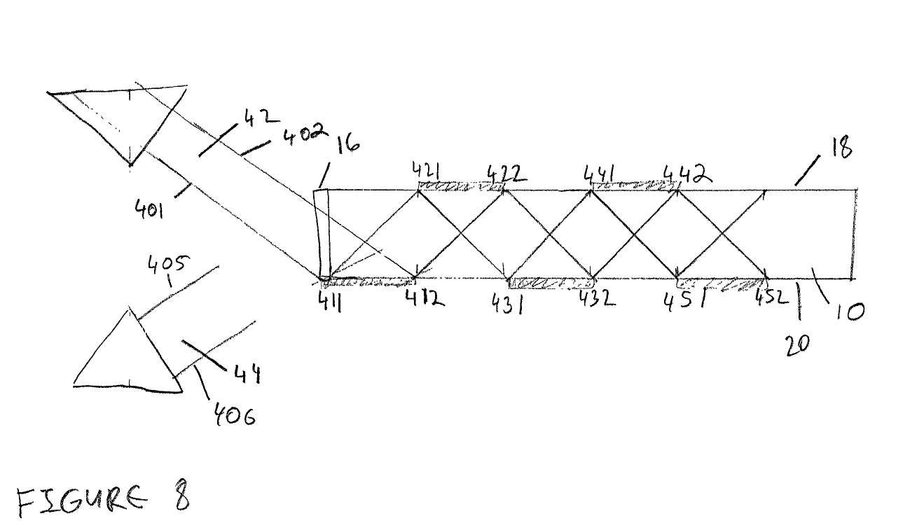

FIG. 8 shows an additional method to achieve uniform illumination of the surface of total reflection with which the object to be illuminated makes contact be uniformly distributed is through the use of two substantially collimated beams, 42 and 44, as the radiation source. Collimated beams 42 and 44 are symmetric, that is they are of equal intensity and are symmetrically disposed about block 10. Further, collimated beams 42 and 44 enter block 10 via entry surface 16 at an angle so that the conditions for total internal reflection are met. Lastly beams 42 and 44 have a width so that each one of beams 42 and 44 complementarily illuminate half of the surfaces of block 10.

In FIG. 8, beam 42, bound by substantially parallel rays 401 and 402 penetrate entry surface 16 and reflect from surfaces of total reflection 20 and 18 of block 10 at points 411, 421, 431, 441, 451 and 412, 422, 432, 442, 452 respectively. Beam 42 uniformly illuminates surface of total reflection 14 between points 411 and 412, between points 421 and 422, between points 431 and 432, and so on (indicted by shading). Beam 44, is bound by substantially parallel rays 405 and 406. Although the path of beam 44 through block 10 is not explicitly traced, study of FIG. 8 makes it clear to one skilled in the art that beam 44 uniformly illuminates the remainder of surfaces 18 and 20.

As is clear to one skilled in the art, a radiation source such as depicted in FIG. 8 can be made, for example using a laser, a beam splitter and a suitably disposed arrangement of lenses and mirrors.

The radiation source depicted in FIG. 8 has one primary advantage over the radiation source depicted in FIGS. 7A and 7B: all radiation rays are incident on the surfaces of total reflection at an identical angle. This can be an advantage when illuminating a transparent object whose index of refraction is less than the index of refraction of the block by guaranteeing that the angle of incidence of the radiation is always large enough to avoid total internal reflection at the block/object interface.

As clear to one skilled in the art, in some cases it is advantageous to use a radiation source that uses a number of radiation beams that is greater than two to uniformly illuminate a block of the device the present invention. As is clear to one skilled in the art, such a radiation source is fashioned in a manner analogous to that of the two-beam radiation source depicted in FIG. 8.

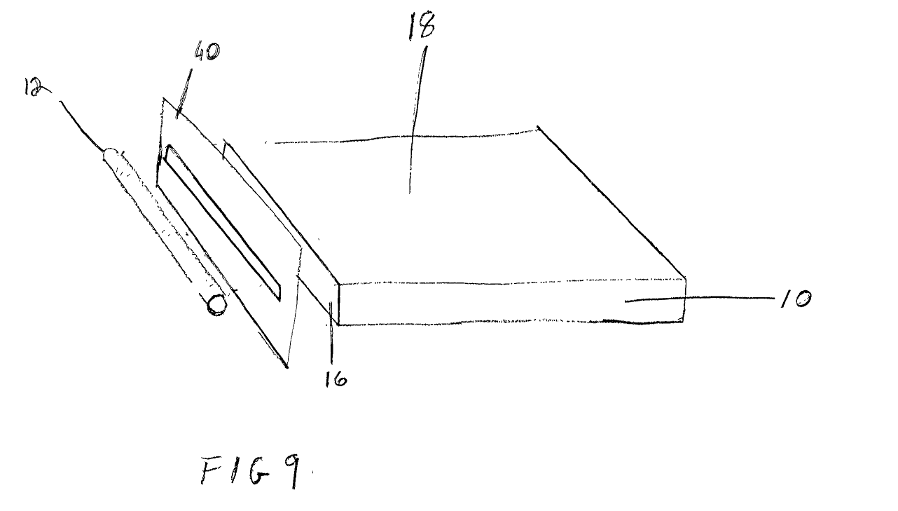

The transparent block of the present invention can have a variety of shapes, four non-limiting examples appearing in FIGS. 9, 10, 11 and 12.

In FIG. 9, transparent block 10 is a parallelopiped. Entry surface 16 is one of the faces of block 10. Two parallel faces act as surfaces of total internal reflection: face 18 and the face parallel to it (not seen in FIG. 9). In FIG. 9, radiation source 12 is a fluorescent lamp accompanied by baffle 40, configured to allow radiation produced by radiation source 12 to enter block 10 through entry surface 16 only under conditions of total internal reflection.

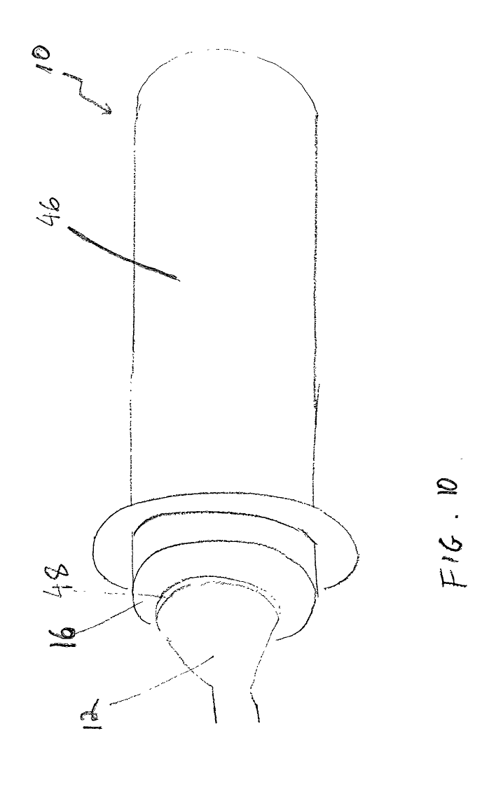

In FIG. 10, transparent block 10 is cylindrical with entry surface 16 being one of the ends of block 10. Curved outer surface 46 of block 10 is a unique surface of total internal reflection. As is clear to one skilled in the art, the raypaths in block 10 of FIG. 10 resemble the raypaths in an optical fiber. Radiation source 12 is a floodlight with a diffusive coating on lens 48.

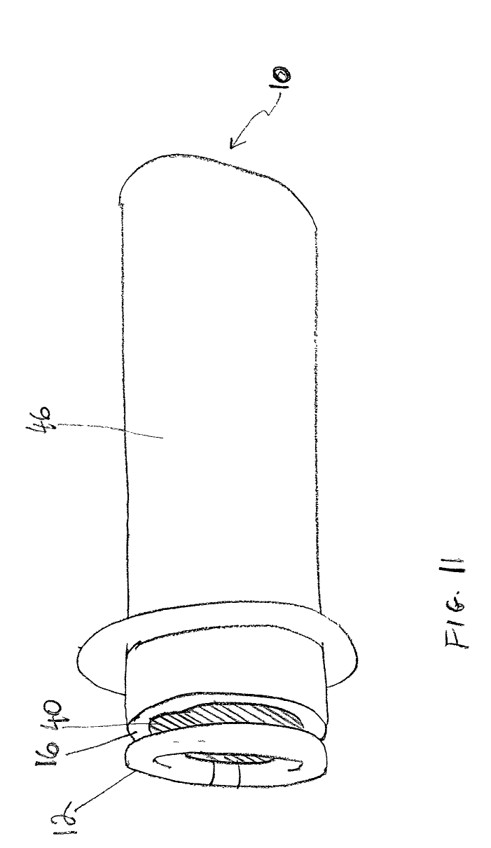

In FIG. 11, transparent block 10 has the shape of a cylindrical tube, with entry surface 16 being one of the ends of block 10. Radiation source 12 is a circular fluorescent bulb. Entry baffle 40 is shaped as a plug inside the end of transparent block 10, preventing the entry of radiation produced by radiation source 12 into transparent block 10 from any surface excepting entry surface 16 and only under conditions of total internal reflection. Curved outer surface 46 and the parallel inner surface (not seen in FIG. 11) of block 10 are the surfaces of total internal reflection.

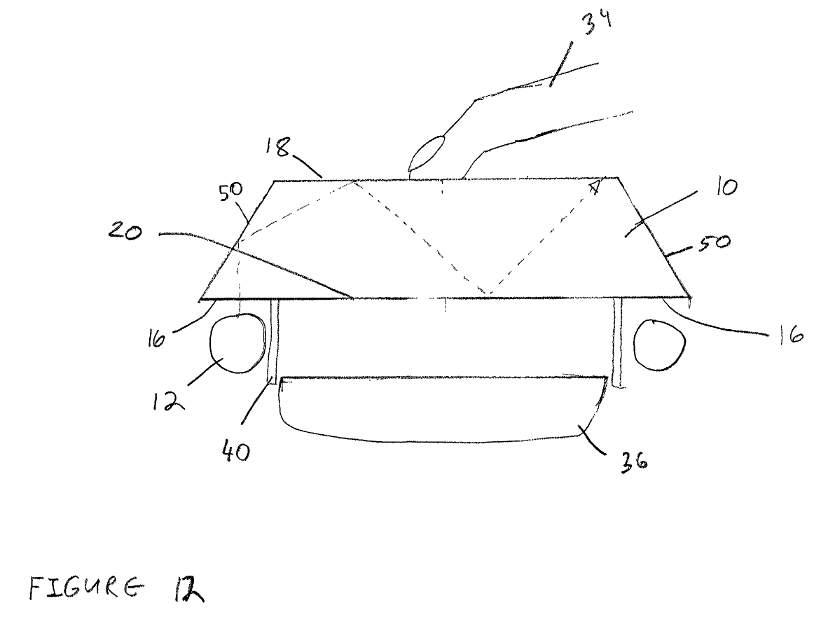

In FIG. 12, transparent block 10 has a saucer shape with a top face 18 a bottom face 20, and a side face 50. Entry surface 16 is a circular region of bottom face 20 in proximity of the edge of bottom face 20. Top face 18, bottom face 20 and side face 50 are surfaces of total reflection. Radiation source 12 is a circular fluorescent tube or a plurality of appropriately arranged point sources of radiation. Ring shaped entry baffle 40 prevents radiation from radiation source 12 entering transparent block 10 excepting under conditions of total internal reflection. As described in FIG. 5, when an object 34 is placed in contact with top face 18, radiation rays reflect from object 34 to be detected by a detector 36.

In FIGS. 9, 10, 11 and 12 specific shapes of a transparent block of the present invention have been described. As is clear to one skilled in the art it is possible, by using an appropriate arrangement of radiation sources, to homogeneously illuminate a surface of total reflection of a transparent block of the present invention where the transparent block has virtually any shape. For example, although saucer shaped transparent block 10 has, by implication, a round shape illuminated by circular fluorescent tube 12, an analogous device of the present invention can be designed wherein transparent block 10 is not round.

While the invention has been described with respect to a limited number of embodiments, it will be appreciated that many variations and modifications of the invention may be made.

1. A device for the illumination of an object comprising:
a) a block substantially transparent to radiation of a certain frequency range, said block having at least one entry surface and at least one surface of total reflection, such that said radiation introduced into said block via said at least one entry surface at a suitable range of angles relative to said at least one surface of total reflection is totally reflected from at least one of said at least one surface of total reflection, and wherein said surface of total reflection is configured to allow contact between said surface of total reflection and the object; and
b) a radiation source for introducing said radiation into said at least one entry surface at said suitable range of angles.

2. The device of claim 1 wherein a portion of said at least one surface of total reflection is shielded from said radiation source by at least one entry baffle.

3. The device of claim 1 wherein at least a portion of at least one of said surface of total reflection is substantially uniformly irradiated by said radiation.

4. The device of claim 1 wherein a portion of said block is substantially shaped as a parallelopiped.

5. The device of claim 1 wherein said radiation source is configured to introduce said electromagnetic radiation into said at least one entry surface as more than one uniform collimated beams.

6. The device of claim 5 wherein said radiation source is configured to introduce said electromagnetic radiation into said at least one entry surface as two uniform collimated beams.

7. The device of claim 1 wherein a portion of said block is substantially shaped as a cylinder.

8. The device of claim 1 wherein a portion of said block is substantially saucer shaped.

9. The device of claim 1 wherein a portion of said block is substantially shaped as a cylindrical tube.

10. The device of claim 1 wherein said block has at least one exit surface such that when an opaque object is placed in contact with at least one of said at least one surface of total reflection and said radiation is introduced through said at least one entry surface at said suitable range of angles, a portion of said radiation is reflected diffusely from said opaque object where said opaque object is in contact with said at least one surface of total reflection and some of said diffusely reflected radiation emerges from said exit surface.

11. The device of claim 10 wherein a portion of said at least one exit surface is shielded by at least one detector baffle.

12. The device of claim 1 wherein said radiation is electromagnetic radiation and said certain frequency range is includes the visible radiation range.

13. The device of claim 1 wherein said radiation is electromagnetic radiation and said certain frequency range is includes the infrared radiation range.

14. The device of claim 1 wherein said radiation is sonic radiaton.

15. The device of claim 1 wherein at least one of said at least one surface of total reflection is configured to be substantially rigid when in contact with the object.

16. A method for uniformly illuminating an object with at least one planar side and transparent to radiation of a certain frequency range, comprising:
a) providing a block, said block being substantially transparent to radiation of the certain frequency range, said block having at least one entry surface and at least one surface of total reflection, said surfaces being such that the radiation introduced to said block via said at least one entry surface at a suitable range of angles relative to said surface of total reflection is reflected at said at least one surface of total reflection;
b) placing the at least one planar side of the object in contact with one of said at least one surface of total reflection; and
c) introducing the radiation into said block via said at least one entry surface at said suitable range of angles.

17. The method of claim 16 wherein a portion of said at least one surface of total reflection is shielded by at least one entry baffle.

18. The device of claim 16 wherein at least a portion of at least one of said surface of total reflection is substantially uniformly irradiated by the radiation.

19. The method of claim 16 wherein a portion of said block is substantially shaped as a parallelopiped.

20. The method of claim 16 wherein said source of radiation is introduced into said at least one entry surface as more than one uniform collimated beams.

21. The method of claim 16 wherein a portion of said block is substantially shaped as a cylinder.

22. The method of claim 16 wherein a portion of said block is substantially shaped as a cylindrical tube.

23. The method of claim 16 wherein at least one of said at least one surface of total reflection is configured to be substantially rigid when in contact with the object.

24. A method for uniformly illuminating an object opaque to radiation of a certain range of frequencies, the opaque object having a plurality of sides, comprising
a) placing the object in contact with a block, said block being substantially transparent to radiation of the certain frequency range, said block having at least one entry surface and at least one surface of total reflection, and at least one exit surface, said surfaces being such that the radiation introduced to said block via said at least one entry surface at a suitable range of angles relative to said surface of total reflection is totally reflected at said at least one surface of total reflection, and said surfaces being such that when the radiation is introduced via said at least one entry surface at said suitable range of angles, some of the radiation is reflected diffusely from said object where said object is in contact with said at least one surface of total reflection, and some of the diffusely reflected radiation emerges from said at least one exit surface; and
b) introducing the radiation into said block via said at least one entry surface at said suitable range of angles.

25. The method of claim 24 wherein a portion of said at least one exit is shielded by at least one detector baffle.

26. The method of claim 24 wherein a portion of said block is substantially shaped as a parallelopiped.

27. The device of claim 24 wherein at least a portion of at least one of said surface of total reflection is substantially uniformly irradiated by the radiation.

28. The method of claim 24 wherein said radiation source is configured to introduce said radiation into said at least one entry surface as more than one uniform collimated beams.

29. The method of claim 24 wherein at least one of said at least one surface of total reflection is configured to be substantially rigid when in contact with the object.
